(19) United States
(12) Patent Application Publication
(10) Pub. No.: US 2024/0191383 A1
(43) Pub. Date: Jun. 13, 2024

(54) Device and Method for the User-Friendly and Reliable Galvanic Growth of a Plurality of Nanowires

(71) Applicant: NanoWired GmbH, Gernsheim (DE)

(72) Inventors: Olav Birlem, Gernsheim (DE); Florian Dassinger, Gernsheim (DE); Sebastian Quednau, Gernsheim (DE); Farough Roustaie, Gernsheim (DE)

(21) Appl. No.: 18/279,428

(22) PCT Filed: Feb. 22, 2022
(86) PCT No.: PCT/EP2022/054382

§ 371 Date: Aug. 30, 2023

(30) Foreign Application Priority Data
Mar. 3, 2021 (DE) 10 2021 105 128.2

(51) Int. Cl. C25D 1/00; C25D 1/04; C25D 17/02; C25D 21/12

(52) U.S. Cl. CPC C25D 1/006; C25D 1/04; C25D 17/02; C25D 21/12

(57) ABSTRACT

Apparatus for galvanically growing a plurality of nanowires on a substrate, comprising a substrate holder and a housing, in which a chamber, a control unit and a storage tank for an electrolyte are arranged, the apparatus being designed to grow the plurality of nanowires from the electrolyte onto the substrate when the substrate holder with the substrate has been inserted into the chamber.

The invention relates to an apparatus and a method for galvanically growing a plurality of nanowires on a substrate.

Apparatuses and methods with which nanowires can be produced are known. For example, nanowires can be obtained by galvanic processes or by means of methods that are known from thin-film technology. It is common to many known methods that they require complex machines, and in particular for this reason are usually only used (can only be used) in laboratories and in clean rooms. In particular, most known methods are not suitable for industrial use.

Also, many known apparatuses and methods have the disadvantage that the nanowires obtained vary greatly in their properties, and in particular with respect to their quality. The nanowires from different growing processes often differ, sometimes considerably, even if the same machines, starting materials and/or formulations are used. The quality of nanowires often depends in particular on the ability of the user of a corresponding apparatus or the user of a corresponding method, on environmental influences and/or also simply on chance. All of this is made more difficult by the fact that nanowires are structures which sometimes cannot even be seen with an optical microscope. Therefore, elaborate investigations may be necessary to make it possible in the first place to ascertain the described properties (and in particular the fluctuations in them).

On this basis, the object of the invention is to provide an apparatus and a method with which a plurality of nanowires can be reliably produced in a particularly user-friendly way.

This object is achieved by the apparatus and the method according to the independent claims. Further advantageous configurations are indicated in the dependent claims. The features represented in the claims and in the description can be combined with one another in any technologically meaningful way.

According to the invention, an apparatus for galvanically growing a plurality of nanowires on a substrate is provided. The apparatus comprises a substrate holder and a housing, in which a chamber, a control unit and a storage tank for an electrolyte are arranged, the apparatus being designed to grow the plurality of nanowires from the electrolyte onto the substrate when the substrate holder with the substrate has been inserted into the chamber.

The described apparatus is preferably designed to grow nanowires in an automated manner. The apparatus may be designed in particular for industrial use.

With the apparatus described, nanowires can be produced. A nanowire is understood here as meaning any body of material that has a wire-like form and a size in the range of a few nanometres to a few micrometres. A nanowire may for example have a circular, oval or polygonal base area. In particular, a nanowire may have a hexagonal base area.

The nanowires preferably have a length in the range from 100 nm [nanometres] to 100 μm [micrometres], in particular in the range from 500 nm to 60 μm. The length of the nanowires is preferably distributed with a standard deviation in the range of 5 to 20%. The nanowires also preferably have a diameter in the range from 10 nm to 10 μm, in particular in the range from 30 nm to 4 μm. Here, the term diameter relates to a circular base area, a comparable definition of a diameter being applicable if the base area deviates from this. It is particularly preferred that all of the nanowires used have the same length and the same diameter.

The described apparatus can be used for a wide variety of materials of the nanowires. Electrically conducting materials, in particular metals such as copper, silver, gold, nickel, tin and platinum, are preferred as the material of the nanowires. Of these, copper is particularly preferred. However, non-conducting materials, such as metal oxides, are also preferred. Preferably, all of the nanowires are formed from the same material.

The nanowires may be grown onto the surface of the substrate with the apparatus.

The surface of the substrate is preferably made to be electrically conducting. If the surface of the substrate is part of a substrate that is otherwise not electrically conducting, the electrical conductivity can be achieved for example by a metallization.

Thus, for example, a substrate that is not electrically conducting may be coated with a thin layer of metal. The metallization can be used in particular to produce an electrode layer. Depending on the material of the surface of the substrate and/or the electrode layer, it may be advisable to provide a bonding layer between the surface of the substrate and the electrode layer that imparts an adhesive bond between the surface of the substrate and the electrode layer.

The electrical conductivity of the surface of the substrate allows it to be used as an electrode for the galvanic growing of the nanowires. The substrate may be in particular a silicon substrate. The substrate may be in particular a body which is provided with electrically conducting structures. It may be in particular a silicon chip or a so-called printed circuit board (PCB). However, the growing of the nanowires is also possible on a large number of other surfaces, for example glass, ceramic and polymer. The substrate may be rigid or flexible. The apparatus is preferably suitable for substrates that have an extent of up to 80 cm in each direction parallel to the surface to be grown on and/or that have an extent of 1 μm to 100 mm transversely to the surface to be grown on. For example, 12-inch wafers may be used as a substrate. Alternatively, the substrate may for example have an extent of 30×40 cm in a plane parallel to the surface to be grown on.

With the apparatus described, the nanowires can be galvanically grown onto the surface of the substrate in pores of a foil. An electrolyte is used for this. For example, 600 ml of the electrolyte may be sufficient to grow nanowires completely over a 12-inch wafer. The electrolyte is provided by the storage tank. The storage tank is preferably filled with the electrolyte. The apparatus also preferably has at least one connection by way of which the storage tank for the electrolyte can be connected in such a way that the electrolyte can be used for the growing of the nanowires. The connection is preferably formed in such a way that the storage tank is opened by the connection when it is connected and is closed by the connection when it is separated from the connection.

The opening and closing of the storage tank therefore takes place automatically. Thus, the tank may have an opening which is closed by a valve which is opened by the connection when connecting the connection and which closes again when the storage tank is separated from the connection. The storage tank is therefore closed if the storage tank is not connected to the connection. Thus, the storage tank can be changed without it being possible for the user to come into contact with the electrolyte. To this extent, the apparatus described is particularly safe. In this configuration, the storage tank may also be referred to as a cartridge.

The nanowires can be provided in a particularly consistent quality if, during the growing, the foil lies closely against the surface of the substrate and the electrolyte is evenly distributed over the foil. For this, an elastic element that is permeable to the electrolyte may lie against the foil. An electrolyte can be released onto the foil through the elastic element and the foil can be held on the surface of the substrate. Once the nanowires have grown to such an extent after a first growing step that the foil is held on the surface of the substrate by the nanowires, the elastic element can be removed. In a second growing step, no elastic element is used, so that the electrolyte can be distributed even more evenly over the surface of the substrate.

The foil is preferably formed by a plastics material, in particular by a polymer material. The foil has a plurality of passing-through pores, in which the nanowires can be grown. The pores are preferably made to pass through the foil by being formed by channels which pass through from an upper side of the foil to an underside of the foil. In particular, it is preferred that the pores are made to be cylindrical. However, it is also possible that the pores are made as channels following a curved path. A pore may have for example a circular, oval or polygonal base area. In particular, a pore may have a hexagonal base area. The pores are preferably formed uniformly (i.e. the pores preferably do not differ with respect to the size, shape, arrangement and/or distance from adjacent pores). When the nanowires are being grown, the pores are preferably filled (in particular completely) with the galvanically deposited material. This makes the nanowires take on the size, shape and arrangement of the pores. The properties of the nanowires to be grown can therefore be established or influenced by the choice of the foil or the pores therein. The foil may therefore also be referred to as a “template”, “template foil” or “pattern”. The pores in the foil can be obtained by the foil being irradiated with high-energy heavy ions. The ions may have energy in the range of MeV to GeV.

Once the nanowires have grown into the pores of the foil, the foil can be removed, for example with a plasma or with a solvent. The nanowires are thereby exposed.

The apparatus has a housing, in which preferably all of the other elements of the apparatus are arranged. To this extent, the apparatus can be considered to be a compact machine. The housing preferably has a base area of at most 1 m² [square metre]. That is possible because in particular the chamber, the control unit and the storage tank for the electrolyte are arranged together in the housing. The housing preferably has a rectangular base area. The housing preferably has a height of 1 to 3 m (metres), in particular of 1.5 to 2.5 m. The housing is preferably formed from a metal, in particular from high-grade steel. The material of the housing preferably has a coating, in particular on an outer side of the housing. Thus, the housing may be formed for example from coated high-grade steel. The housing may be protected by the coating from chemicals.

The housing encloses the chamber, into which a substrate holder can be inserted. The chamber preferably has a receptacle for the substrate holder. The substrate holder is designed to hold the substrate on which the nanowires are to be grown. Once the substrate holder with the substrate has been inserted into the chamber, the nanowires can be grown onto the substrate. This takes place by the nanowires being galvanically grown from the electrolyte onto a surface of the substrate.

The substrate holder is preferably formed as a drawer. This means that the substrate holder can be pushed into the receptacle, for example over guide rails arranged laterally in the chamber. It is preferred that the drawer can be separated completely from the rest of the apparatus. Alternatively, the amount by which the drawer can be pulled out may be limited to a maximum extent, so that the drawer cannot be pulled out beyond the maximum extent.

The apparatus preferably has a drive for moving the substrate holder. For example, the substrate holder may be brought manually into a loading position and from there be drawn into the receptacle in an automated manner by the drive. After completion of the growing of the nanowires, the substrate holder may be moved out of the receptacle in an automated manner, in particular into a removal position, which is preferably identical to the loading position. From the removal position, the substrate holder can be removed manually. Alternatively, the apparatus may be designed to move the substrate holder into the receptacle out of the receptacle completely manually. It is also conceivable that an apparatus with a drive for the substrate holder is operated according to choice with an automatically moved substrate holder or a manually moved substrate holder.

The apparatus preferably has an arresting mechanism for arresting the substrate holder in the receptacle. The arresting mechanism is preferably formed such that the arresting mechanism has an active state and a deactivated state. The arresting mechanism can therefore be switched on and off. An electromagnet which in the switched-on state holds the substrate holder in the receptacle may be provided for example for this. Thus, with the arresting mechanism, the substrate holder can be secured in the receptacle during the growing of the nanowires. After completion of the growing of the nanowires, the arresting mechanism can be deactivated and the substrate holder can be removed from the receptacle.

The chamber is preferably closable. For example, the chamber may be accessible by way of an opening in a housing wall, so that the substrate holder can be inserted into the chamber and into the receptacle through the opening. The opening may for example be closable by a flap. In the closed state, the chamber is preferably liquid- and gas-tight.

Thus, an atmosphere desired for the growing of the nanowires can be created inside the chamber. Moreover, chemicals can be prevented from escaping from the chamber. The chamber may preferably be locked. Thus, the opening may for example be closed by a flap and the flap may be held in its position by a locking mechanism. Consequently, inadvertent opening of the chamber during a growing process can be prevented. The chamber is preferably formed within a bounding enclosure of a material that is resistant to the chemicals used when growing the nanowires, for example steel or plastic.

The chamber preferably has a respective feed for at least one chemical. For example, the electrolyte used for growing the nanowires may be provided in this way. The electrolyte may for example be introduced by way of the corresponding feed into a depression of the substrate holder, so that the electrolyte comes into contact with the substrate arranged in the depression. Furthermore, a feed for water may be provided, in particular for deionized water (DI water). This may be used for rinsing the substrate after completion of the growing of the nanowires. It can in this way be prevented that residual amounts of the electrolyte leave the apparatus with the substrate. Furthermore, the chamber preferably has at least one outlet. Thus, for example, an outlet by way of which the electrolyte can be let out of the chamber after completion of the growing of the nanowires may be provided. An outlet for the water used for rinsing may also be provided. The electrolyte and the water may be let out of the chamber by way of the same outlet or by way of different outlets. Furthermore, the chamber preferably has a ventilating opening. This allows gases in the chamber to be let out of the chamber. Thus, a user can be protected from harmful gases escaping from the chamber when it is opened. The gases can be extracted from the chamber by way of the ventilating opening and replaced for example by fresh air or an inert atmosphere. The extracted gases may for example be cleaned. Furthermore, an electrode designed for the growing of the nanowires is preferably arranged in the chamber. Thus, an electrical voltage may be applied between the electrode and the surface to be grown on of the substrate in order to grow the nanowires. The electrode is preferably held on a ram. The ram is preferably automatically movable. Thus, the ram can be used to bring the electrode into contact with the electrolyte in order to grow the nanowires. This may involve an elastic element such as a sponge that is placed on the foil being pressed onto the foil by the ram. The foil can in this way be held in its position. The ram may also have an electrolyte distributor. Thus, the electrolyte can be fed by way of the ram to the surface to be grown on of the substrate. The electrolyte distributor may have a plurality of outlets on an outlet side, so that the electrolyte can be fed by way of the electrolyte distributor uniformly to the surface to be grown on of the substrate. The electrode may be formed on the outlet side of the electrolyte distributor. Thus, the outlets may adjoin corresponding through-openings in the electrode, so that the electrolyte can pass through the electrode by way of the through-openings.

Also arranged in the housing is a control unit. The control unit is preferably designed to control the growing of the nanowires. For this, the control unit may for example set the electrical voltage or the electrical current that is used for the growing of the nanowires. Moreover, the control unit may set a dosage, a pressure and/or a through-flow of the electrolyte. The control unit allows the growing of the nanowires to take place in an automated manner. The control unit is preferably designed to set a length of the nanowires to be grown and/or a growth rate.

The storage tank preferably has an identification, by way of which the control unit can identify the storage tank. For this, the control unit may be attached to an identification sensor. For example, the identification may be a barcode, which can be detected by a barcode scanner as an identification sensor. The identification may also be an RFID chip, which can be detected by a corresponding reader as an identification sensor. It can for example be detected by the identification of the storage tank whether the correct electrolyte has been provided.

The substrate holder preferably has electronics which are designed to influence the growing of the nanowires. The control unit is preferably connected to the substrate holder by way of an interface when the substrate holder has been inserted into the chamber. The interface may for example comprise one or more plug-in connections. The plug-in connections are preferably formed in such a way that the electronics of the substrate holder are connected to the control unit when the substrate holder has been inserted into the receptacle. A separate manipulation by an operator, for example the connecting of cables, is in this case not required.

The control unit is preferably designed to process signals output by the electronics of the substrate holder and/or to output control signals to the electronics of the substrate holder. The control unit preferably has a database and/or is designed to access an external database. For example, the control unit may communicate with an external database by way of an Internet connection. Parameters which have been transmitted from the electronics of the substrate holder to the control unit can be compared with corresponding expected values from the database. In the case of discrepancies, for example a warning signal may be emitted, the process may be interrupted and/or a correction may be performed in an automated manner by way of a corresponding control signal. Also by way of a corresponding control signal, a heater of the substrate holder may be controlled by the control unit. The heater allows a temperature of the substrate to be set.

Furthermore, the apparatus preferably has a display means and/or an operating means, which are in particular connected to the control unit. The display means and/or the operating means are preferably held in or on the housing in such a way that they are accessible for a user. The display means allows information on the growing process to be indicated to the user, and the operating means allows the user to control the process. The display means and the operating means may also be formed as a display and operating means, for example as a touchscreen.

If the apparatus has an arresting mechanism for arresting the substrate holder in the receptacle, the control unit is preferably designed to monitor and/or control the arresting mechanism. If the apparatus has a drive for moving the substrate holder, the control unit is preferably designed to monitor and/or control the drive. If the apparatus has a chamber which is closable by a flap that can be locked by a locking mechanism, the control unit is preferably designed to monitor and/or control the locking mechanism. For example, the control unit may detect that the substrate holder has been placed into the loading position and, in response to this, initiate by way of corresponding control signals that the substrate holder is drawn into the receptacle in an automated manner and arrested there by the arresting mechanism and that the opening of the chamber is closed by the flap and the flap is locked. During the growing of the nanowires, the control unit may monitor that the arresting mechanism and the locking mechanism are and remain active. After completion of the growing of the nanowires, the control unit may initiate by corresponding control signals that the locking mechanism of the flap is released and the flap is opened and that the arresting mechanism is released and the substrate holder is moved into the removal position in an automated manner.

The substrate is preferably prepared in a clean room. For this, a structuring layer into which clearances are introduced, for example by a lithographic process, may be applied to it. Depending on the type of structuring layer, the nanowires can only be grown in the clearances or can only be grown outside the clearances. Thus, the nanowires can be grown locally selectively onto the substrate. If, for example, nanowires are only to be obtained on metal pads, these pads may first be created lithographically. If the surface of the substrate outside the pads is not electrically conducting, the pads for the galvanic growing of the nanowires may for example be connected by a 100 nm layer of gold or copper being grown onto a 20 nm layer of chromium or tungsten-titanium. After the growing, these layers, with the unwanted nanowires located on them, can be removed by lift-off or selective etching. The pads may for example have an edge length of 3 μm and a pitch of 3 μm. As a further part of the preparation of the substrate, the surface to be grown on may be cleaned and activated, for example with an oxygen plasma. The oxygen plasma may be used for example at 350 mbar, 100 W for one minute. As a further part of the preparation of the substrate, the foil may be placed onto the substrate itself or, if a structuring layer is used, onto the structuring layer. The elastic element may also be placed onto the foil as part of the preparation of the substrate.

Once the substrate has been prepared, it does not have to be kept under clean-room conditions any longer. After preparation, the substrate can be removed from the clean room and fed to the apparatus described. The apparatus may be used outside a clean room. It therefore does not have to conform to clean-room requirements. Nevertheless, it is preferred that the apparatus is formed in conformity with clean-room requirements. If the apparatus is used in a clean room, the nanowires grown with the apparatus can also be protected after removal of the substrate holder from the chamber.

In a further preferred embodiment, the apparatus has a multiplicity of receiving spaces for a respective storage tank for an electrolyte.

The receiving spaces are preferably formed in the housing, in particular outside the chamber. The apparatus also preferably has at least one connection by way of which a storage tank for an electrolyte can be connected in such a way that the corresponding electrolyte can be used for the growing of the nanowires. If a number of storage tanks are arranged in a corresponding receiving space in the housing, the connection may be connected according to choice to one of the storage tanks. If there is more than one connection, a number of storage tanks may be connected simultaneously. In that case, the control unit can be used to select which one or ones of the corresponding electrolytes is/are used for the growing of the nanowires. The apparatus may have a respective connection for each of the receiving spaces.

In a further preferred embodiment, the apparatus has a multiplicity of storage tanks for a respective electrolyte. Particularly preferably, the storage tanks are filled with a respective electrolyte. In this case, the storage tanks may be filled with the same electrolyte or with different electrolytes. The storage tanks preferably have an identification, by way of which the control unit can identify the storage tanks.

In a further preferred embodiment, the apparatus comprises an electrolyte processor. The electrolyte processor is preferably arranged in the housing. The electrolyte processor is designed to process the electrolyte used for the growing of the nanowires. The electrolyte processed in this way can be used for a further growing process. The electrolyte may be processed with the electrolyte processor after each growing process or each time after a certain number of growing processes. The electrolyte processor may also be designed for different ways of processing the electrolyte. Thus, for example, a first processing may be carried out after each growing process and a second processing may be carried out instead of the first processing each time after a certain number of growing processes. This is advisable in particular if the second processing is more intensive than the first processing. The electrolyte processor is preferably designed to clean the electrolyte. Alternatively or in addition, the electrolyte processor is designed to add a substance to the electrolyte. This allows the chemical composition of the electrolyte to be changed. For this, the electrolyte processor may be attached to a corresponding tank in which the substance is provided.

In a further preferred embodiment, the apparatus is designed to clean in an automated manner regions that come into contact with the electrolyte during operation.

The apparatus may be designed in particular to clean the chamber, in particular an inner side of the chamber. In addition, the apparatus may be designed to clean electrolyte lines. The cleaning preferably takes place in an automated manner, for example by spraying the inner side of the chamber with a cleaning fluid and/or by passing a cleaning fluid through the electrolyte lines. The cleaning fluid may be water. The apparatus may be cleaned after one growing process for a following growing process, in particular if the growing processes are carried out with different electrolytes.

In a further preferred embodiment, the chamber has a compressed-air feed.

The compressed-air feed can be used to introduce compressed air into the chamber, for example in order to remove a liquid from the substrate after completion of the growing process. For this, the compressed air may be directed onto the substrate inside the chamber through a nozzle and/or through an automatically moved compressed-air hose. Alternatively or in addition, the compressed air may also be used for cleaning the chamber.

In a further preferred embodiment of the apparatus, an inner side of the chamber is formed from an electrolyte-resistant material, preferably from plastic.

In a further preferred embodiment of the apparatus, the control unit is designed to determine at least one parameter assigned to the storage tank.

The storage tank may have an identification. The control unit can in that case determine the at least one parameter assigned to the storage tank by the control unit retrieving the at least one parameter from a database after the storage tank has been identified. Alternatively, the apparatus may comprise one or more sensors, with which the at least one parameter can be determined and transmitted to the control unit.

The following come into consideration in particular as parameters assigned to the storage tank: an age of the electrolyte in the storage tank, a chemical composition of the electrolyte in the storage tank, a filling level of the electrolyte in the storage tank, a temperature of the electrolyte in the storage tank.

In a further preferred embodiment of the apparatus, the control unit is designed to determine a flow and/or a pressure of the electrolyte. The “and” case is preferred.

By measuring the flow and/or the pressure of the electrolyte, it can be determined how much electrolyte is available for the growing of the nanowires. The flow and/or the pressure of the electrolyte are preferably measured in an electrolyte line by way of which the electrolyte can be passed from the storage tank into the chamber. Preferably, the flow and/or the pressure of the electrolyte are controlled by the control unit to a predetermined setpoint value.

In a further preferred embodiment, the apparatus also has a pump for pumping the electrolyte out of the storage tank into the chamber, the pump being held in a damped manner on a support, which is held in a damped manner in the housing.

The pump is preferably connected to the storage tank by way of the connection. The electrolyte can be passed from the storage tank into the chamber by way of an electrolyte line. The electrolyte line may protrude into the chamber in such a way that the electrolyte can be introduced into a depression of the substrate holder inside the chamber. Once the substrate has been placed into the depression, the substrate can thus be brought into contact with the electrolyte.

The pump may cause vibrations. These can impair the growing process of the nanowires. The pump is therefore held in a damped manner. In the present embodiment, the pump is damped doubly, to the extent that the pump is held in a damped manner on a support which is held in a damped manner in the housing.

In a further preferred embodiment of the apparatus, a filter for the electrolyte is also arranged in the housing.

The filter is preferably a particulate filter or an activated carbon filter. Particularly preferably, two filters for the electrolyte are arranged in the housing. In this case, one of the filters may be a particulate filter and the other filter may be an activated carbon filter. The particulate filter may be used after each growing process, while the activated carbon filter is used instead of the particulate filter each time after a certain number of growing processes.

The filter or filters is/are preferably part of the electrolyte processor. The particulate filter may be used for the first processing, while the activated carbon filter is used for the second processing.

In a preferred embodiment of the apparatus, a gripper for removing an elastic element resting on the substrate is arranged in the chamber.

With the gripper, the elastic element can be removed from the foil in an automated manner. This allows the entire method to be carried out in an automated manner, whereby errors can be avoided. The gripper may for example be formed as a needle gripper.

In this embodiment, the nanowires can be grown in two growing time periods. Thus, in a first growing time period, the elastic element may lie against the foil. The elastic element thereby allows the foil to be held on the substrate. Subsequently, the elastic element may be lifted off from the foil with the gripper. In a second growing process, the nanowires may be grown without the elastic element. This is possible because the foil is already held on the substrate by the nanowires. Without the elastic element, the electrolyte can distribute itself better, so that more uniform growth of the nanowires can be achieved.

In a further preferred embodiment, the apparatus also comprises an (in particular electrically driven) mangle for squeezing out the electrolyte from the elastic element when the elastic element has been removed from the foil with the gripper.

The mangle may have two rollers, between which the elastic element is moved through. In this case, a pressure can be exerted on the elastic element by the rollers, so that the elastic element releases electrolyte that is present in the elastic element. In this way, a considerable part of the electrolyte can be removed from the elastic element and re-used.

In a further preferred embodiment of the apparatus, a movable rest can be arranged in the chamber in such a way that the elastic element can be placed on the movable rest with the gripper.

The elastic element may be gripped with the gripper and lifted off from the surface of the substrate. Subsequently, the movable rest may be pushed between the surface of the substrate and the elastic element. The elastic element may be placed onto the movable rest and released by the gripper. Subsequently, the elastic element may be transported away with the movable rest. Subsequently, the elastic element may be removed from the movable rest. This may take place in an automated manner, for example by the movable rest being moved in such a way that, from a separating point, the elastic element can longer follow the movement of the movable element. The separating point may for example be obtained as a result of the movable rest being guided into a rest receptacle that does not provide any space for the elastic element. The elastic element in this case is left hanging on the edge of the rest receptacle. The elastic element may be deposited in a compartment, from which the elastic element can be manually removed.

The movable rest may be moved in an automated manner, for example by a motor. The movable rest is preferably formed from a flexible material, for example from plastic. Thus, the movable rest can be stowed in a space-saving manner when it is not required. For example, the movable rest may be guided by way of a deflecting roller, so that, when it is not required, the movable rest can be stowed in a position turned by 90° with respect to the surface of the substrate.

In a further preferred embodiment, the apparatus also comprises a cleaning device for cleaning the movable rest.

The cleaning device is preferably designed to spray a cleaning fluid onto the movable rest. This may take place for example after the elastic element has been transported away with the movable rest or has been removed from it. The cleaning device is preferably arranged in such a way that the movable rest is guided past the cleaning device once the elastic element has been removed from the movable rest.

In a further preferred embodiment, the apparatus also comprises a voltage source, which is connected to an electrode and the substrate for applying an electrical voltage for the growing of the nanowires.

The voltage source serves for providing the electrical current required for the galvanic growing. For this, the voltage source is connected to the substrate, in particular to the surface to be grown on of the substrate. The voltage source is preferably designed to generate a pulsed voltage, in particular with a pulse frequency in the range from 0.1 to 10 ms. It has been shown by tests that, with a pulsed voltage, the quality of the nanowires can be improved.

In a further preferred embodiment, the arrangement also comprises a reference electrode, which is connected to the surface of the substrate.

With the reference electrode, the growing of the nanowires can be monitored. For this, the voltage between the electrode and the reference electrode can be measured with the reference electrode. The arrangement may comprise one or more reference electrodes.

The electrode is preferably connected to the voltage source by way of a first cable. The surface to be grown on of the substrate is preferably connected to the voltage source by way of a second cable. The reference electrode is preferably connected to a voltmeter by way of a third cable. The surface of the substrate is preferably connected to the voltmeter by a fourth cable, in particular independently of the second cable. The second cable and the fourth cable are preferably connected in each case directly to the surface of the substrate. For this, the surface of the substrate may have a respective contact pad, by way of which the second cable and the fourth cable are connected to the surface of the substrate, for example by means of a respective conducting tape. The reference electrode is therefore not simply connected to the surface of the substrate by the reference electrode being connected by a branching of the second cable. It has been found that, by comparison, a direct attachment of the reference electrode to the surface of the substrate produces more accurate results.

The substrate and the reference electrode are preferably jointly held by the substrate holder when the nanowires are being grown onto the substrate.

The first cable, the second cable, the third cable and the fourth cable may in each case be divided into a number of portions, which are connected to one another for example by way of plug-in connections. The second cable, the third cable and/or the fourth cable may in each case be divided into portions in such a way that a respective transition between two adjacent portions of the corresponding cable is arranged at an edge of the substrate holder formed as a drawer. The drawer may have a corresponding connector for each of these three cables. Thus, electrical contact between the surface of the substrate and the reference electrode may be made when the drawer is pushed into the receptacle by the three plug-in connections being formed. The voltmeter and the voltage source are preferably arranged inside the housing and outside the chamber.

As a further aspect of the invention, a description is given of a method for galvanically growing a plurality of nanowires onto a substrate by an apparatus which has a substrate holder and a housing with a chamber, a control unit and a storage tank for an electrolyte, and the method comprising:
a) placing the substrate into the substrate holder,
b) inserting the substrate holder into the chamber,
c) galvanically growing the nanowires from the electrolyte onto the substrate.

The particular advantages and features of the apparatus can be applied and transferred to the method, and vice versa. The apparatus is preferably designed for being operated according to the method. The method is preferably carried out with the apparatus described.

In step c), the substrate is preferably heated. In step c), a temperature of the substrate preferably lies between 15° C. and 100° C.

In a further preferred embodiment of the method, before step a), an elastic element is placed onto the substrate, step c) being carried out for a first growing time period, and the method also comprising:
d) removing the elastic element with a gripper, and
e) for a second growing time period, continuing the galvanic growing of the plurality of nanowires from the electrolyte.

The invention is explained in more detail below on the basis of the figures. The figures show a particularly preferred exemplary embodiment, to which, however, the invention is not restricted. The figures and the relative sizes shown therein are only schematic. In the figures:

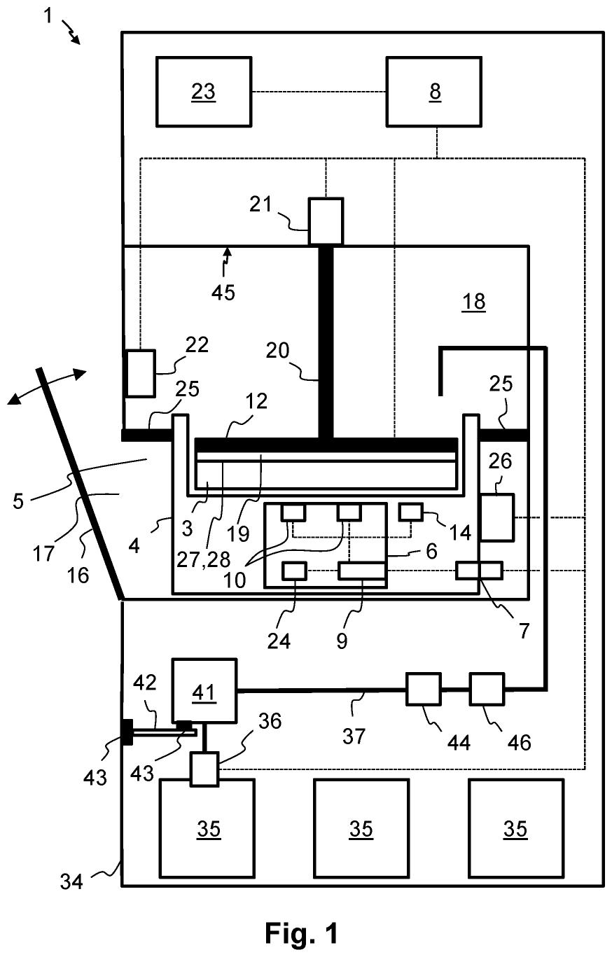

FIG. 1: shows an apparatus according to the invention for galvanically growing a plurality of nanowires on a substrate,

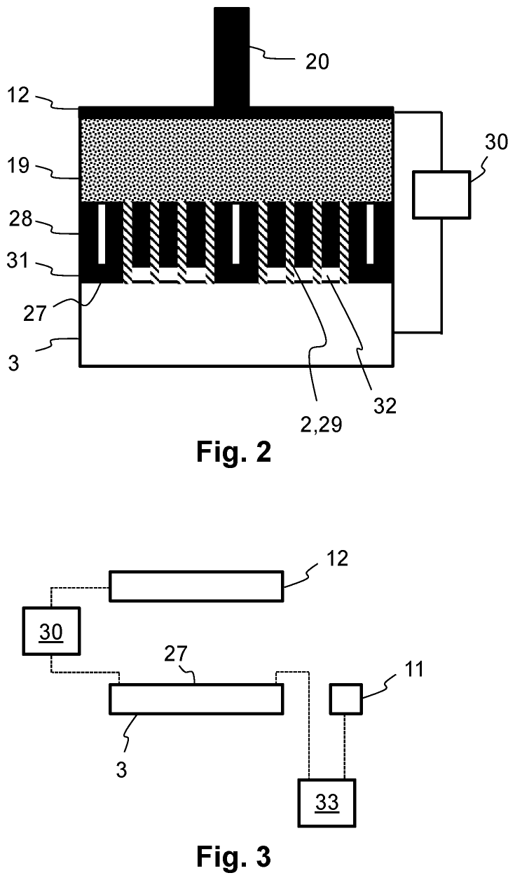

FIG. 2: shows a schematic representation of part of the apparatus from FIG. 1,

FIG. 3: shows a connection of a reference electrode for the apparatus from FIGS. 1 and 2,

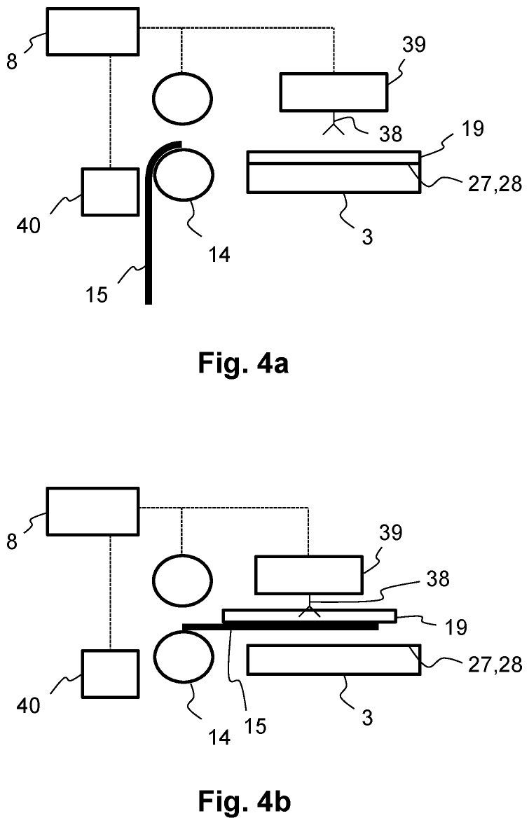

FIGS. 4a and 4b: show further elements of the arrangement from FIGS. 1 and 2 in two different states.

FIG. 1 shows an apparatus 1 for galvanically growing a plurality of nanowires 2 (shown in FIG. 2) onto a surface 27 of a substrate 3. The apparatus 1 comprises a substrate holder 4, formed as a drawer, and a receptacle 5 for the substrate holder 4, formed in a chamber 18. The receptacle 5 has guide rails 25, over which the substrate holder 4 can be pushed into the receptacle 5 and can be pulled out from the receptacle 5. With an arresting mechanism 26, the substrate holder 4 can be arrested in the receptacle 5.

In the situation shown in FIG. 1, the substrate holder 4 has been received by the receptacle 5. The apparatus 1 is designed to grow the plurality of nanowires 2 on the substrate 3 when the substrate holder 4 with the substrate 3 has been received in the receptacle 5, as shown. The substrate holder 4 has electronics 6, which are designed to influence the growing of the nanowires 1. The substrate holder 4 has an interface 7, which is formed as a plug-in connection and by way of which the electronics 6 are connected to a control unit 8 of the apparatus 1 when the substrate holder 4 has been received in the receptacle 5, as shown. The control unit 8 is also connected to a touchscreen as a display and operating means 23. The control unit 8 is designed in particular to determine a flow and/or a pressure of the electrolyte.

With the apparatus 1, the following method for galvanically growing a plurality of nanowires 2 on the substrate 3 can be carried out:
a) placing the substrate 3 into the substrate holder 4,
b) inserting the substrate holder 4 into the chamber 18,
c) galvanically growing the nanowires 2 on the substrate 3.

On the substrate 3 there lies a foil 28 (which cannot be seen in detail in FIG. 1) with passing-through pores 29 (which can be seen in FIG. 2). On the foil 28 there lies a sponge as an elastic element 19, by way of which an electrolyte can be released onto the foil 28. On the elastic element 19 there lies an electrode 12. By applying an electrical voltage between the surface 27 of the substrate 3 and the electrode 12, the nanowires 2 can be grown. The electrode 12 is held by way of a ram 20 and, using this, can be moved by means of a drive 21.

The electronics 6 of the substrate holder 4 influence the growing of the nanowires 2 according to step c). The electronics 6 of the substrate holder 4 comprise a digitizing unit 9, which is connected to the control unit 8 for digital communication. Furthermore, the electronics 6 of the substrate holder 4 comprise a sensory 10, which in the embodiment shown is formed by two sensors. Moreover, the electronics 6 of the substrate holder 4 comprise a memory 24. In this there may be stored, for example, growth parameters that are taken into account during the growing of the nanowires 2. In addition, the electronics 6 of the substrate holder 4 are designed to control an electrical voltage or an electrical current for the growing of the nanowires 2. The electronics 6 are also attached to a heater 14, with which the substrate 3 can be heated.

The apparatus 1 has a housing 3 inside which the chamber 18 is formed. An inner side 45 of the chamber 18 is formed from an electrolyte-resistant material. The receptacle 5 for the substrate holder 4 is formed in the chamber 18, so that the substrate holder 4 can be received by the chamber 18. The chamber 18 has an opening 17, by way of which the substrate holder 4 can be inserted into the chamber 18 and can be moved out of the chamber 18. The opening 17 may be closed by way of a flap 16. The flap 16 may be locked with a locking mechanism 22. The apparatus 1 is designed to grow the plurality of nanowires 2 from the electrolyte onto the substrate 3 when the substrate holder 4 with the substrate 3 has been inserted into the chamber 18.

Also arranged in the housing 34 are three storage tanks 35 for a respective electrolyte. One of the storage tanks 35 is attached to an electrolyte line 37 by way of a connection 36 and a pump 41. By way of the electrolyte line 37, the electrolyte can be introduced into the substrate holder 4 and used for the growing of the nanowires 2. The pump 41 is designed to pump the electrolyte out of the storage tank 25 into the chamber 18. The pump 41 is held in a damped manner by means of a damper 43 on a support 42, which is held in a damped manner by way of a further damper 43 in the housing 34. The connection 36 has a sensor (not shown any more specifically), with which the storage tank 35 can be identified by way of the control unit 8 and at least one parameter assigned to the storage tank 35 can be determined. Also arranged in the housing 24 are a filter 44 for the electrolyte and an electrolyte processor 46. In the embodiment shown, the filter 44 and the electrolyte processor 46 are integrated in the electrolyte line 37.

Details of the electrode processor 46 are not shown for the sake of overall clarity. Thus, the electrolyte processor 46 may for example be connected by way of a line to a tank by way of which substances that can be used for processing the electrolyte are fed to the electrolyte processor 46.

FIG. 2 shows part of the apparatus 1 from FIG. 1 in a schematic representation. The substrate 3 is shown, with the surface 27 of the substrate 3 onto which the nanowires 2 are to be grown. A foil 28, which has a plurality of passing-through pores 29, in which the nanowires 2 can be grown from an electrolyte, has been placed onto the surface 27 of the substrate 3. The surface 27 of the substrate 3 has a structuring layer 31 with clearances 32. The nanowires 2 can only be grown in the clearances 32. Thus, the growing of the nanowires 2 can take place locally selectively. Furthermore, the elastic element 19 permeable to the electrolyte has been placed onto the foil 28. The electrolyte can be brought into contact with the foil 28 by way of the elastic element 19. Also shown in FIG. 2 is a voltage source 30 (not shown in FIG. 1 for the sake of overall clarity), which is connected to an electrode 12 and the surface 27 of the substrate 3 for applying an electrical voltage for the growing of the nanowires 2. The voltage source 30 is also connected to the control unit 8. The electrode 12 may be pressed against the elastic element 19 with a ram 20.

FIG. 3 shows further elements of the apparatus 1 from FIGS. 1 and 2. For the sake of overall clarity, not all of the elements from FIGS. 1 and 2 are shown in FIG. 3, and vice versa. Thus, along with the voltage source 30, the electrode 12 and the substrate 3 with the surface 27, also shown in FIG. 3 is a reference electrode 11. The reference electrode 11 is connected to the surface 27 of the substrate 3 by way of a voltmeter 33. The voltage source 30 and the reference electrode 11 are attached to the surface 27 of the substrate 3 independently of one another.

FIGS. 4a and 4b show further elements of the apparatus 1 from FIGS. 1 and 2. For the sake of overall clarity, not all of the elements from FIGS. 1 and 2 are shown in FIGS. 4a and 4b, and vice versa. It can be seen from FIGS. 4a and 4b in particular that the apparatus 1 has a gripper 28 for removing the elastic element 19 from the foil 28. Shown in FIG. 4a is the state in which the elastic element 19 on the foil 28 rests on the surface 27 of the substrate 3. The elastic element 19 may be gripped with the gripper 38 and lifted off from the surface 27 of the substrate 3. This is shown in FIG. 4b. The apparatus 1 comprises a drive 39 for automatically actuating the gripper 38. Moreover, the apparatus 1 comprises a movable rest 15 for the elastic element 19. In FIG. 4a, the movable rest 15 is stowed in a position turned by 90° with respect to the surface 27 of the substrate 3 because the movable rest 15 is not required in the state shown. In FIG. 4b, the movable rest 15 has been pushed between the surface 27 of the substrate 3 and the elastic element 19. In this way, the elastic element 19 can be placed onto the movable rest 15.

Subsequently, the elastic element 19 can be transported away with the movable rest 15, by the movable rest 15 being moved back into its state shown in FIG. 4a. The elastic element 19 can thus come away from the movable rest 15 for example by the elastic element 19 not following the downward movement of the movable rest 15. As soon as the elastic element 19 has come away from the movable rest 15, the movable rest 15 can be cleaned with a cleaning device 40. For this, the movable rest 15 can be sprayed with a cleaning fluid by the cleaning device 40. The apparatus 1 also has an electrically driven mangle 13 for squeezing out the electrolyte from the elastic element 19 when the elastic element 19 has been removed from the foil 28 with the gripper 38. The mangle 13 has two rollers, between which the elastic element 19 can be moved through under the effect of a force.

With the gripper 38, the method described for FIG. 1 can be carried out to the extent that, before step a), an elastic element 19 is placed onto the substrate 3, that step c) is carried out for a first growing time period, and that the method also comprises: d) removing the elastic element 19 with the gripper 38, and
e) for a second growing time period, continuing the galvanic growing of the plurality of nanowires 2 from the electrolyte.

### LIST OF REFERENCE SIGNS

1 Apparatus
2 Nanowires
3 Substrate
4 Substrate holder
5 Receptacle
6 Electronics
7 Interface
8 Control unit
9 Digitizing unit
10 Sensory
11 Reference electrode
12 Electrode
13 Mangle
14 Heater
15 Movable rest
16 Flap
17 Opening
18 Chamber
19 Elastic element
20 Ram
21 Drive
22 Locking mechanism
23 Display and operating means
24 Memory
25 Guide rail
26 Arresting mechanism
27 Surface
28 Foil
29 Pore
30 Voltage source
31 Structuring layer
32 Clearance
33 Voltmeter
34 Housing
35 Storage tank
36 Connection
37 Electrolyte line
38 Gripper
39 Drive
40 Cleaning device
41 Pump
42 Support
43 Damper
44 Filter
45 Inner side
46 Electrolyte processor

1. Apparatus for galvanically growing a plurality of nanowires on a substrate, comprising a substrate holder and a housing, in which a chamber, a control unit and a storage tank for an electrolyte are arranged, the apparatus being designed to grow the plurality of nanowires from the electrolyte onto the substrate when the substrate holder with the substrate has been inserted into the chamber.

2. Apparatus according to claim 1, wherein an inner side of the chamber is formed from an electrolyte-resistant material.

3. Apparatus according to claim 1, wherein the control unit is designed to determine at least one parameter assigned to the storage tank.

4. Apparatus according to claim 1, wherein the control unit is designed to determine a flow and/or a pressure of the electrolyte.

5. Apparatus according to claim 1, also having a pump for pumping the electrolyte out of the storage tank into the chamber, the pump being held in a damped manner on a support, which is held in a damped manner in the housing.

6. Apparatus according to claim 1, wherein a filter for the electrolyte is also arranged in the housing.

7. Apparatus according to claim 1, wherein a gripper for removing an elastic element resting on the substrate is arranged in the chamber.

8. Apparatus according to claim 7, wherein a movable rest can be arranged in the chamber in such a way that the elastic element can be placed on the movable rest with the gripper.

9. Method for galvanically growing a plurality of nanowires onto a substrate by an apparatus which has a substrate holder and a housing with a chamber, a control unit and a storage tank for an electrolyte, and the method comprising:
a) placing the substrate into the substrate holder,
b) inserting the substrate holder into the chamber,
c) galvanically growing the nanowires from the electrolyte onto the substrate.

10. Method according to claim 9, wherein, before step a), an elastic element is placed onto the substrate, step c) being carried out for a first growing time period, and the method also comprising:
d) removing the elastic element with a gripper, and
e) for a second growing time period, continuing the galvanic growing of the plurality of nanowires from the electrolyte.

11. Apparatus according to claim 2, wherein the control unit is designed to determine at least one parameter assigned to the storage tank.

12. Apparatus according to claim 2, wherein the control unit is designed to determine a flow and/or a pressure of the electrolyte.

13. Apparatus according to claim 2, also having a pump for pumping the electrolyte out of the storage tank into the chamber, the pump being held in a damped manner on a support, which is held in a damped manner in the housing.

14. Apparatus according to claim 2, wherein a filter for the electrolyte is also arranged in the housing.

15. Apparatus according to claim 2, wherein a gripper for removing an elastic element resting on the substrate is arranged in the chamber.

16. Apparatus according to claim 15, wherein a movable rest can be arranged in the chamber in such a way that the elastic element can be placed on the movable rest with the gripper.

17. Apparatus according to claim 3, wherein the control unit is designed to determine at least one parameter assigned to the storage tank.

18. Apparatus according to claim 3, wherein the control unit is designed to determine a flow and/or a pressure of the electrolyte.

19. Apparatus according to claim 3, also having a pump for pumping the electrolyte out of the storage tank into the chamber, the pump being held in a damped manner on a support, which is held in a damped manner in the housing.

20. Apparatus according to claim 3, wherein a filter for the electrolyte is also arranged in the housing.
